(19) United States
(12) Patent Application Publication
(10) Pub. No.: US 2009/0168803 A1
(43) Pub. Date: Jul. 2, 2009

(54) METHOD AND APPARATUS FOR DYNAMICALLY CHANGING THE SIGNALING FORMAT OF MESSAGING CONTROL INFORMATION

(75) Inventors: Stavros Tzavidas, Evanston, IL (US); John M. Harris, Glenview, IL (US); Hua Xu, Lake Zurich, IL (US); Xiao Xu, Palatine, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/248,946

(22) Filed: Oct. 10, 2008

Related U.S. Application Data
(60) Provisional application No. 61/017,923, filed on Dec. 31, 2007.

(51) Int. Cl. H04J 3/22

(52) U.S. Cl. 370/471

(57) ABSTRACT

For a packet, a communication device determines (12) a length of a packet length field based on one or more of the following: a size of a transmit region allocated for a remote unit, a size of a transmit region allocated for a remote unit and not to be used for at least one other packet, and/or whether the packet length of the packet is indicated by a history of packet lengths of previously transmitted packets. The communication device may also or alternatively determine (22) a length of a connection identifier field based on a number of connection identifiers previously established. The communication device then transmits (13, 23) the packet, which includes the field(s) of determined length. By determining the lengths of these fields in this manner, the fields may be made shorter and their use may potentially reduce signaling overhead as compared to using the present-day fixed-length fields.

### FIELD OF THE INVENTION

The present invention relates generally to data communication and, in particular, to dynamically changing the signaling format of messaging control information.

### BACKGROUND OF THE INVENTION

In wireless interfaces such as those based on the IEEE (Institute of Electrical and Electronics Engineers) 802.16 air interface or the WiMAX air interface, overhead signaling can consume a substantial portion of the total signaling capacity of the interface. For example, approximately 38% of WiMAX radio resources are consumed by BTS (base transceiver station)/MS (mobile station) MAC (media access control) PDU (packet data unit) overhead for small-payload packets like VoIP (voice-over-IP). In these packets, 6 bytes are used for the generic MAC header (GMH). The 16-bit transport connection ID (CID), which is used to indicate which of the user's connections/flows the packet is for, and the 11-bit Length field are the two biggest fields in the GMH. Thus, new techniques able to reduce the size of the CID field and/or the length field would be desirable for reducing the overhead signaling in these and other communication interfaces.

### BRIEF DESCRIPTION OF THE DRAWINGS

FIG. 1 is a logic flow diagram of functionality performed by a communication device in accordance with multiple embodiments of the present invention.

FIG. 2 is a logic flow diagram of functionality performed by a communication device in accordance with multiple embodiments of the present invention.

FIG. 3 is a block diagram depiction of a wireless communication system in accordance with multiple embodiments of the present invention.

FIG. 4 is a signaling flow diagram that depicts a procedure for switching from implicit transport CID index (ITCI) to normal 16-bit transport CID and then back, in accordance with certain embodiments of the present invention.

FIG. 5 is a signaling flow diagram that depicts the use of a “typical” packet length, in accordance with certain embodiments of the present invention.

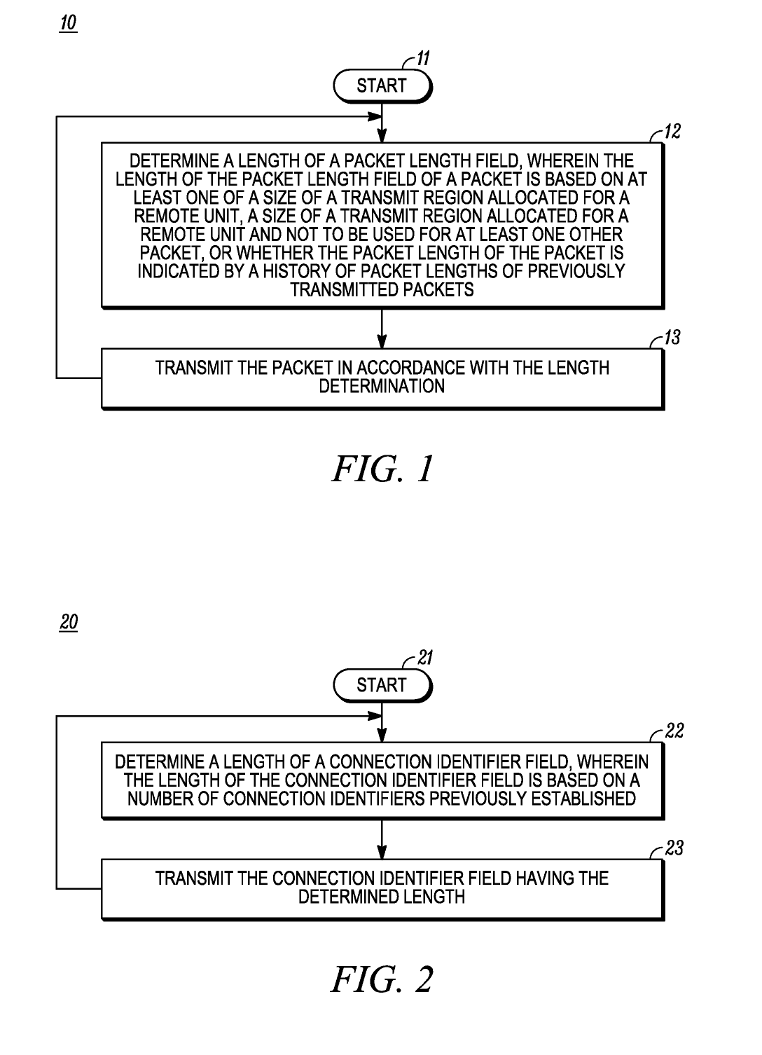

Specific embodiments of the present invention are disclosed below with reference to FIGS. 1-5. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the signaling flow diagrams and/or the logic flow diagrams above are described and shown with reference to specific signaling exchanged and/or specific functionality performed in a specific order, some of the signaling/functionality may be omitted or some of the signaling/functionality may be combined, sub-divided, or reordered without departing from the scope of the claims. Thus, unless specifically indicated, the order and grouping of the signaling/functionality depicted is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### Detailed Description of Embodiments

Various embodiments are described for dynamically changing the signaling format of messaging control information. Logic flow diagrams 10 and 20, in FIGS. 1 and 2, depict functionality performed in accordance with multiple embodiments of the present invention. For a packet, a communication device determines (12) a length of a packet length field based on one or more of the following: a size of a transmit region allocated for a remote unit, a size of a transmit region allocated for a remote unit and not to be used for at least one other packet, and/or whether the packet length of the packet is indicated by a history of packet lengths of previously transmitted packets. The communication device may also or alternatively determine (22) a length of a connection identifier field based on a number of connection identifiers previously established. The communication device then transmits (13, 23) the packet, which includes the field(s) of determined length. By determining the lengths of these fields in this manner, the fields may be made shorter and their use may potentially reduce signaling overhead as compared to using the present-day fixed-length fields.

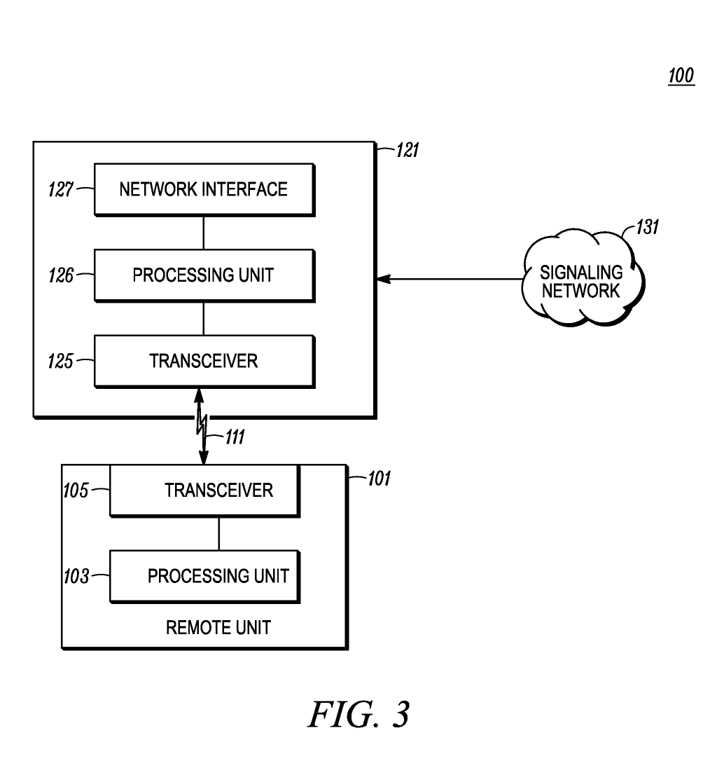

The disclosed embodiments can be more fully understood with reference now to FIGS. 3-5. FIG. 3 is a block diagram depiction of a wireless communication system 100 in accordance with multiple embodiments of the present invention. At present, standards bodies such as OMA (Open Mobile Alliance), 3GPP (3rd Generation Partnership Project), 3GPP2 (3rd Generation Partnership Project 2), IEEE (Institute of Electrical and Electronics Engineers) 802, and WiMAX Forum are developing standards specifications for wireless telecommunications systems. (These groups may be contacted via http://www.openmobilealliance.com, http://www.3gpp.org/, http://www.3gpp2.com/, http://www.ieee802.org/, and http://www.wimaxforum.org/ respectively.) Communication system 100 represents a system having an architecture in accordance with one or more of the WiMAX Forum and/or IEEE 802 technologies, suitably modified to implement the present invention. Alternative embodiments of the present invention may be implemented in communication systems that employ other or additional technologies such as, but not limited to, those described in the OMA, 3GPP, and/or 3GPP2 specifications.

Communication system 100 is depicted in a very generalized manner. For example, system 100 is shown to simply include remote unit 101, network node 121 and signaling network 131. Network node 121 is shown having interconnectivity via signaling network 131. Network node 121 is shown providing network service to remote unit 101 using wireless interface 111. The wireless interface used is in accordance with the particular access technology supported by network node 121, such as one based on IEEE 802.16. Those skilled in the art will recognize that FIG. 3 does not depict all of the physical fixed network components that may be necessary for system 100 to operate but only those system components and logical entities particularly relevant to the description of embodiments herein.

As depicted in FIG. 3, network node 121 comprises a processing unit 126, a network interface 127 and a transceiver 125. In general, components such as processing units, transceivers and network interfaces are well-known. For example, processing units are known to comprise basic components such as, but neither limited to nor necessarily requiring, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using signaling flow diagrams, and/or expressed using logic flow diagrams.

Thus, given a high-level description, an algorithm, a logic flow, a messaging/signaling flow, and/or a protocol specification, those skilled in the art are aware of the many design and development techniques available to implement a processing unit that performs the given logic. Therefore, device 121 represents a known device that has been adapted, in accordance with the description herein, to implement multiple embodiments of the present invention. Furthermore, those skilled in the art will recognize that aspects of the present invention may be implemented in or across various physical components and none are necessarily limited to single platform implementations. For example, a network node may be implemented in or across one or more RAN components, such as a base transceiver station (BTS) and/or a base station controller (BSC), a Node-B and/or a radio network controller (RNC), or an HRPD AN and/or PCF, or implemented in or across one or more access network (AN) components, such as an access service network (ASN) gateway and/or ASN base station (BS), an access point (AP), a wideband base station (WBS), and/or a WLAN (wireless local area network) station.

Remote unit 101 and network node 121 are shown communicating via technology-dependent, wireless interface 111. Remote units, subscriber stations (SSs) and/or user equipment (UEs), may be thought of as mobile stations (MSs), mobile subscriber stations (MSSs), mobile devices or mobile nodes (MNs). In addition, remote unit platforms are known to refer to a wide variety of consumer electronic platforms such as, but not limited to, mobile stations (MSs), access terminals (ATs), terminal equipment, mobile devices, gaming devices, personal computers, and personal digital assistants (PDAs). In particular, remote unit 101 comprises a processing unit (103) and transceiver (105). Depending on the embodiment, remote unit 101 may additionally comprise a keypad (not shown), a speaker (not shown), a microphone (not shown), and a display (not shown). Processing units, transceivers, keypads, speakers, microphones, and displays as used in remote units are all well-known in the art.

Operation of embodiments in accordance with the present invention occurs substantially as follows, first with reference to FIG. 3. As depicted in FIG. 3, network node 121 is a current serving node for remote unit 101. For the sake of example, it will be assumed that wireless interface 111 supports multiple network connections for individual remote units such as remote unit 101. Depending on the embodiment, these multiple connections may comprise different transport connections for individual applications running on the remote unit or multiple transport connections utilized by the same application. In either case, connection identifiers are used to distinguish between the individual connections.

Embodiments of the present invention may be implemented in either a network node or a remote unit. Thus, either a network node or a remote unit may be determining a length, as described below, and then sending a packet in accordance with this determination. For the sake of example, it will be assumed that network node 121 is preparing to send a packet of information to remote unit 101. This may be information that network node 121 has received from signaling network 131 via network interface 127 or information originating from network node 121. In either case, processing unit 126 determines the length of a connection identifier field and/or a packet length field in the packet, depending on the embodiment. For the sake of example, processing unit 126 will be assumed to do both; however, it could do either one or both for any given packet and even change which it does from packet to packet.

Processing unit 126 determines the length of the connection identifier field for the packet based on a number of connection identifiers previously established. If there is only one connection identifier that has been previously established the length of the connection identifier field may be zero, effectively removing the field since it is therefore not needed. In embodiments such as those based on WiMAX and/or IEEE 802.16, the contents of the connection identifier field indicate a transport connection ID (CID) to which the packet corresponds. These contents may form an index into a list of CIDs that are currently assigned to remote unit 101. In some embodiments, both the network node 121 and remote unit 101 would understand that the index refers to a list of CIDs, currently assigned to remote unit 101, in which the CIDs in the list are ordered numerically. In other embodiments, both the network node 121 and remote unit 101 would understand that the index refers to a list of CIDs that are ordered in the same order in which each CID was assigned.

By using a CID index rather than the CID itself (a 16-bit value in WiMax/IEEE 802.16) the length of the connection identifier field may be shortened. In fact, the connection identifier field may only be a minimum number of bits that are needed to convey the index into the list of CIDs. In this case, the connection identifier field would have a variable length based on the number of CIDs in the list that is being indexed.

In embodiments in which the connection identifier field contains an index into the list of CIDs that are currently assigned to remote unit 101, some coordination between the network node and remote unit may be desirable to avoid confusion during periods in which the number of connection identifiers is changing. Thus, the length of the connection identifier field may be further based on whether a change in the number of connection identifiers established is in process. For example, the length of the connection identifier field may be determined to be some predetermined length (such as the 16-bit value presently used in WiMax/IEEE 802.16) when such a change is in process. Processing unit 126 may in fact transmit, via transceiver 125, an indication that the connection identifier field will now have the predetermined length. When the change in the number of connection identifiers is completed, processing unit 126 may then transmit an indication that the connection identifier field will return to a variable length based on the number of connection identifiers established with remote unit 101.

In addition to or instead of determining the length of a connection identifier field, processing unit 126 may determine the length of a packet length field. It does so based on a size of a transmit region allocated for remote unit 101, based on a size of a transmit region allocated for remote unit 101 and not to be used for one or more other packets, and/or based on whether the packet length of the packet is indicated by a history of packet lengths of previously transmitted packets. For example, since the packet is not going to be longer than the transmit region allocated, processing unit 126 may determine the length of the packet length field to be a minimum number of bits needed to convey the size of the transmit region.

If other packets are also being transmitted in the allocated transmit region, then processing unit 126 could determine the length of the packet length field to be a minimum number of bits needed to convey the size of the transmit region that is not being used for the other packets. Again, a smaller packet length field can be used since the packet is assumed to not be longer than the remainder of the allocated transmit region. The value represented by the expression Ceiling(log 2(T−Z))) may be used to calculate the length of the packet length field, where T represents the total number of bytes that can be transmitted in the transmit region and Z represents the total number of bytes that has been used for other packets that will be transmitted in the same transmit region. In some embodiments, it may be desirable to cap the length of the packet length field to 11 bits, as expressed by Min(11,Ceiling(log 2(T−Z))).

Processing unit 126 may also or alternatively determine the length of the packet length field based on whether the packet length of the packet is indicated by a history of the packet lengths of previously transmitted packets, such as packets that are associated with remote unit 101 and/or packets that are associated with the same data flow as the packet that processing unit 126 is preparing for transmission. For example, when the last X packets transmitted have the same length or when most of the last Y packets transmitted have the same length (X and Y having predetermined values), the packet length of the present packet may be indicated by the packet length history of these previously transmitted packets.

So, if X is 5 and the previous 5 packets had the same length and the present packet is also to have the same length, then the packet length of the present packet may be indicated by this packet length history. Alternatively, if Y is 10 and 5 or more of the previous 10 packets had the same length and the present packet is also to have the same length, then the packet length of the present packet may be indicated by this packet length history. When the packet length of the present packet is indicated in one of these implicit manners, processing unit 126 may determine that the length of the packet length field is zero and that it can therefore be omitted. In such a case, processing unit 126 may transmit an indication (such as a flag in the packet itself) that the packet length field is omitted. By using a smaller packet length field or even omitting the packet length field when possible, rather than always using a fixed packet length field (such as the 11-bit value in WiMax/IEEE 802.16) overhead signaling may be reduced and potentially replaced with a greater amount of user data.

Having determined for a packet the length of the connection identifier field and/or the length of the packet length field, processing unit 126 sends the packet to remote unit 101 via transceiver 125. As noted above, embodiments of the present invention may be implemented in either a network node or a remote unit. Thus, either a network node or a remote unit may be determining a length, as described above, and then sending a packet in accordance with this determination. Therefore, the operation of processing unit 126 and transceiver 125 could have been described from the perspective of remote unit operation, that is, as the operation of processing unit 103 and transceiver 105.

Reference has been made to WiMax embodiments above. Therefore, a summary that focuses on certain WiMax embodiments appears below to provide some additional and more particular examples. They are intended to further the reader's understanding of the variety of possible embodiments rather than to limit the scope of the invention.

In certain WiMax embodiments, a base transceiver station (BTS) and a mobile station (MS) agree that the number of CID bits transmitted by the transmitter is a function of the number of transport CIDs established by/for the user. One will note that in the case of WiMAX, where CIDs are unidirectional, this rule may be applied to the CIDs for downlink and uplink independently. Transport CIDs for a user are indexed based on the order of their establishments at both transmitter and receiver implicitly. The implicit transport CID index (ITCI) is conveyed in the generic MAC header CID field to replace the 16-bit transport CID during MAC PDU transmission.

If the number of transport CIDs established by the user is: 1, then 0 CID bits are used by the transmitter; if X, where X>1, then the transmitter uses roundup(log 2(X)) bits in the CID field. The ITCI index i is transmitted if the transport CID is the i-th transport CID assigned to that user. Since the order of the flow that is added to the user is known by both transmitter and receiver, the mapping of the transport CID vs. index that is used in the transport CID field in the generic MAC header (GMH) is known to both sides without explicitly being exchanged out.

Both MS and BTS know how many transport CIDs are currently assigned to the user so the scheduler (at the BTS) can each time allocate just enough space for the needed number of bits. To manage the transition period of adding/removing a flow to/from a user, the current rsv bit in GMH is used to indicate if ITCI is used. This bit is called I-flag. The I-flag is set by the transmitter. If the I-flag is set to 0, a traditional 802.16e 1.0 transport CID field is used, i.e., a 16-bit field for the transport CID. If the I-flag is set to 1, a shortened, variable-length ITCI is used instead.

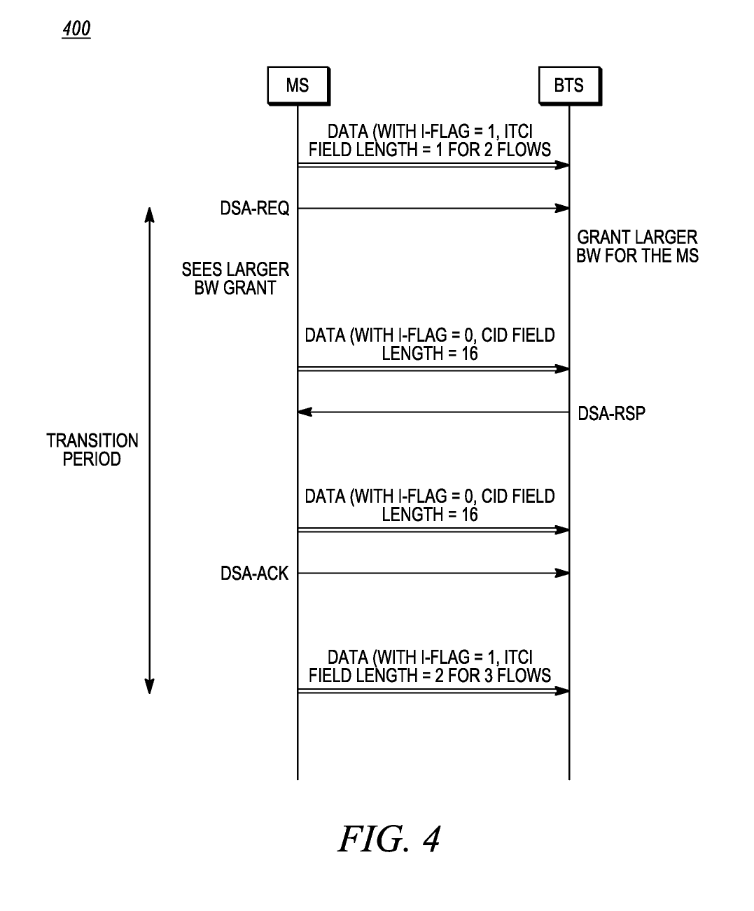

FIG. 4 is a signaling flow diagram that depicts a procedure for switching from implicit transport CID index (ITCI) to normal 16-bit transport CID and then back, in accordance with certain embodiments of the present invention. Diagram 400 illustrates an example in which an MS is using 2 flows initially and then requests a third flow. The change from 2 flows to 3 results in the ITCI field length expanding from 1 bit to 2.

In addition to an implicit transport CID index, certain WiMax embodiments may also utilize an implicit length field in the GMH. For example, an MS and BTS may effectively negotiate a “typical” MAC packet size, possibly after observing traffic and possibly for each of the MS's CIDs. A bit in each packet indicates whether a typical size is used or not. For example, “1” means typical size, i.e., no length field is needed, while “0” means not typical size, i.e., the normal 11-bit length field is used. The transmitter and receiver both interpret “typical size” to be the most frequent packet size out of last 10 packets. The transmitter may then use the 1 bit notation once the “typical size” has been implicitly conveyed in this manner.

Instead of or in addition to establishing a typical size, as described above, the size of the length field may be variable. For example, the size may be determined as the value of Min(11,Ceiling(log 2(T−Z))), where T is total MAC PDU bytes that can be transmitted in the assigned (forward or reverse link) block based on block's size and MCS for that user, Z is total actual MAC PDU bytes that has been used by the previous packets that will be transmitted in the assigned block for that user, and (T−Z) is the remaining MAC PDU bytes (for the current packet, so its length field will be mo more than Ceiling(log 2(T−Z)). The length field may be either in bytes or in units of resource allocation, e.g., clusters/slots in 802.16/WiMAX or resource blocks (RBs) in LTE.

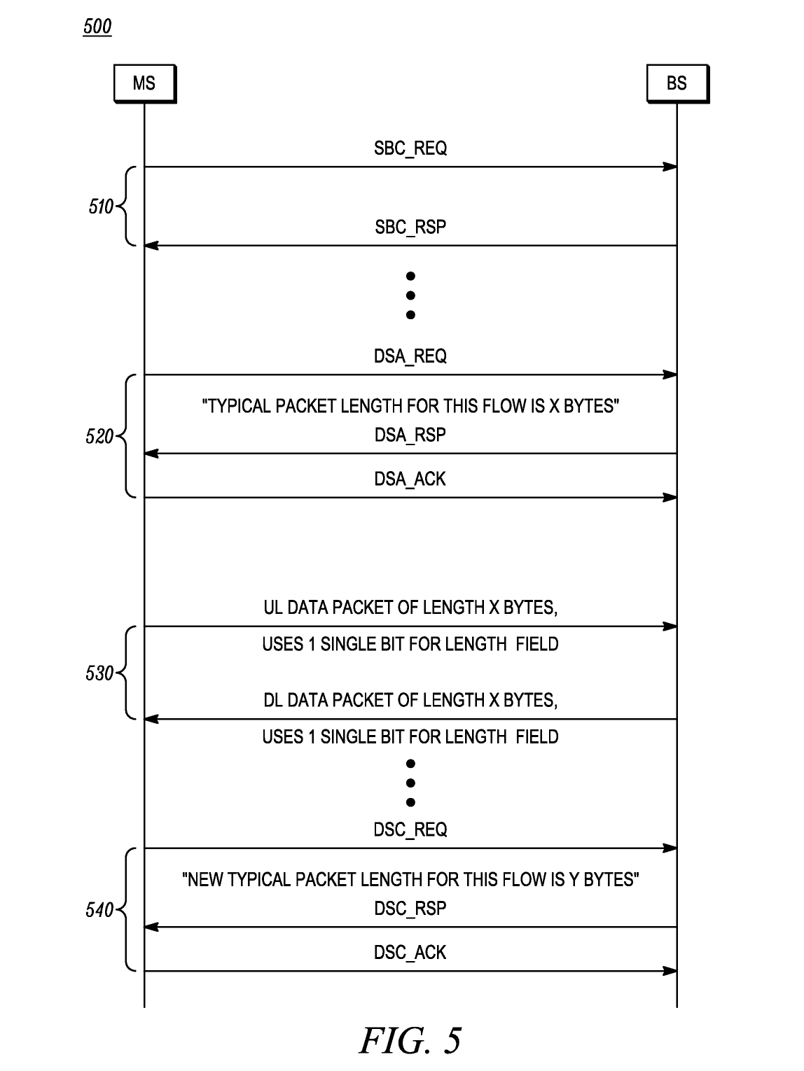

FIG. 5 is a signaling flow diagram that depicts the use of a “typical” packet length, in accordance with certain embodiments of the present invention. During network entry (messaging 510) the MS and BS indicate whether they support the implicit/variable packet length field signaling. When a new flow is established (messaging 520), the MS and BS negotiate the “typical packet length” for this flow. Data packets are exchanged (messaging 530) using reduced MAC overhead, since only a single bit is used for the length field. Although not depicted in diagram 500, typical length X may be different for UL (uplink) and DL (downlink) and different for different flows. The typical length can change (messaging 540) over the course of a flow. Finally, without typical length, the length field should not exceed the value of log 2(size of the granted region).

Reference has been made to IEEE 802.16 embodiments above. Therefore, a summary that focuses on certain IEEE 802.16 embodiments (such as 802.16m embodiments) appears below to provide some additional and more particular examples. They are intended to further the reader's understanding of the variety of possible embodiments rather than to limit the scope of the invention.

In certain 802.16 embodiments, a base transceiver station (BTS) and a mobile station (MS) agree that the number of CID bits transmitted in the generic MAC header (GMH) by the transmitter is a function of the number of transport CIDs established by/for the user. A number of implementation options exist.

Option 1: The original 16-bit transport CID field in the GMH is replaced by an implicit transport CID indicator (I-flag) and the implicit transport CID index (ITCI), where the I-flag indicates whether the a regular CID (16 bit) or an implicit CID index (ITCI) is used in the GMH. Also, ITCIs for a user shall be indexed based on either (a) the order of the flow setup at both transmitter and receiver implicitly, (b) the numerical order of the 16-bit transport CIDs (i.e., the smallest transport CID will be flow index 0), or (c) either option (a) or (b) are used after grouping the flows based on some characteristic such as quality of service (QoS). If the number of transport CIDs established by the user is X (where X>0), then the transmitter uses roundup(log 2(X)) bits in the ITCI field.

Option 2: The original 16 bit transport CID field in GMH is replaced by the ITCI using setup by a new TLV, called ITCI timing. The ITCI timing TLV will be sent during the DSA-REQ/RSP or DSD-REQ/RSP to indicate when the length of the ITCI field changes. The value of the TLV indicates the number of frames between the trigger (inclusive) and the execution (inclusive). The trigger can be the frame of an event, such as the frame that transmits the DSA-REQ message. If the TLV value is 3, then the length of the ITCI field will change in the second frame after the trigger frame. With option 2, the I-flag is not needed. If a packet was initially transmitted using a certain length ITCI field, and it is corrupted and needs retransmission when the length of the ITCI field has changed, the retransmission packet should use the original length ITCI field in order to facilitate Chase combining.

Option 3: Follow the normal DSA/DSD-REQ/RSP/ACK message flow. After DSA/DSD-RSP/ACK, there will be a time window when the number of flows will change. During this time window, receiver shall assume both the ITCI lengths before/after and decode twice if the first decoding attempt fails. This eliminates the need for either the I-flag or the new ITCI timing TLV.

Since the transport CID represented by each ITCI is known by both transmitter and receiver, the mapping of the transport CID vs. ITCI in the GMH is known to both sides without being explicitly exchanged. Both the MS and BTS know how many transport CIDs are currently assigned to the user so the scheduler (at the BTS) can each time allocate just enough space for the needed number of bits for ITCI. To manage the transition period of adding/removing a flow to/from a user, the current rsv bit in the GMH may be used as an I-flag to indicate whether ITCI is used. The I-flag is set by the transmitter. If I-flag is set to 0, a traditional 802.16e 1.0 transport CID field is used, i.e., a 16-bit field for transport CID. If I-flag is set to 1, a shortened variable length ITCI is used. When a flow is added/removed for a user, the procedure of switching from using ITCI to the normal 16-bit transport CID and back is illustrated by way of example in FIG. 4.

One of skill in the art will appreciate that various modifications and changes may be made to the specific embodiments described above with respect to FIGS. 3-5 without departing from the spirit and scope of the present invention. Thus, the discussion of certain embodiments in greater detail above is to be regarded as illustrative and exemplary rather than restrictive or all-encompassing, and all such modifications to the specific embodiments described above are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, and the like, are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the information or object being indicated. Some, but not all examples of techniques available for communicating or referencing the information or object being indicated include the conveyance of the information or object being indicated, the conveyance of an identifier of the information or object being indicated, the conveyance of information used to generate the information or object being indicated, the conveyance of some part or portion of the information or object being indicated, the conveyance of some derivation of the information or object being indicated, and the conveyance of some symbol representing the information or object being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A communication device for dynamically changing the signaling format of messaging control information, the communication device comprising:
a transceiver;
a processing unit, communicatively coupled to the transceiver,
adapted to determine a length of at least one of a connection identifier field or a packet length field, wherein the length of the connection identifier field is based on a number of connection identifiers previously established, wherein the length of the packet length field of a packet is based on at least one of
a size of a transmit region allocated for a remote unit,
a size of a transmit region allocated for a remote unit and not to be used for at least one other packet, or
whether the packet length of the packet is indicated by a history of packet lengths of previously transmitted packets,
the processing unit further adapted to send, via the transceiver and in accordance with the length determined, at least one of the connection identifier field having the determined length or the packet.

2. The method of claim 1, wherein contents of the connection identifier field indicate a transport connection ID (CID) to which a packet transmission corresponds, wherein the contents of the connection identifier field comprise an index into a list of CIDs currently assigned to a remote unit, and wherein the length of the connection identifier field is a minimum number of bits needed to convey the index into the list of CIDs.

3. The method of claim 1, wherein the length of the packet length field is zero when the packet length of the packet is indicated by a history of packet lengths of previously transmitted packets.

4. The method of claim 1, wherein the length of the packet length field of the packet is at least one of
a minimum number of bits needed to convey the size of the transmit region,
a minimum number of bits needed to convey the size of the transmit region and not to be used for at least one other packet,
a value represented by the expression Ceiling(log 2(T−Z))), or
a value represented by the expression Min(11,Ceiling(log 2(T−Z))), wherein T represents the total number of bytes that can be transmitted in the transmit region and Z represents the total number of bytes that has been used for other packets that will be transmitted in the transmit region.

5. A method for dynamically changing the signaling format of messaging control information, the method comprising:
determining a length of a packet length field, wherein the length of the packet length field of a packet is based on at least one of
a size of a transmit region allocated for a remote unit,
a size of a transmit region allocated for a remote unit and not to be used for at least one other packet, or
whether the packet length of the packet is indicated by a history of packet lengths of previously transmitted packets;
transmitting, in accordance with the determining, the packet.

6. The method of claim 5, wherein the length of the packet length field is zero when the packet length of the packet is indicated by a history of packet lengths of previously transmitted packets.

7. The method of claim 6, wherein the packet length of the packet is one of
the same length as that of a last X packets or
the same length as that of most of a last Y packets, wherein X and Y are predetermined values.

8. The method of claim 5, wherein the previously transmitted packets are packets associated with at least one of a same remote unit or a same data flow.

9. The method of claim 5, further comprises transmitting an indication that the packet length field is omitted when the length of the packet length field is determined to be zero.

10. The method of claim 5, wherein the length of the packet length field of the packet is at least one of
a minimum number of bits needed to convey the size of the transmit region,
a minimum number of bits needed to convey the size of the transmit region and not to be used for at least one other packet,
a value represented by the expression Ceiling(log 2(T−Z))), or
a value represented by the expression Min(11,Ceiling(log 2(T−Z))), wherein T represents the total number of bytes that can be transmitted in the transmit region and Z represents the total number of bytes that has been used for other packets that will be transmitted in the transmit region.

11. A method for dynamically changing the signaling format of messaging control information, the method comprising:
determining a length of a connection identifier field, wherein the length of the connection identifier field is based on a number of connection identifiers previously established;
transmitting the connection identifier field having the determined length.

12. The method of claim 11, wherein the length of the connection identifier field is zero when only one connection identifier has been previously established.

13. The method of claim 11, wherein contents of the connection identifier field indicate a transport connection ID (CID) to which a packet transmission corresponds.

14. The method of claim 13, wherein the contents of the connection identifier field comprise an index into a list of CIDs currently assigned to a remote unit.

15. The method of claim 14, wherein the length of the connection identifier field is a minimum number of bits needed to convey the index into the list of CIDs.

16. The method of claim 14, wherein the list of CIDs comprises CIDs currently assigned to the remote unit that are ordered numerically.

17. The method of claim 14, wherein the list of CIDs comprises CIDs currently assigned to the remote unit that are ordered in the same order in which each CID was assigned.

18. The method of claim 11, wherein the length of the connection identifier field is further based on whether a change in the number of connection identifiers established is in process.

19. The method of claim 18,
wherein the length of the connection identifier field is determined to be a predetermined length when a change in the number of connection identifiers established is in process,
wherein the method further comprises transmitting an indication that the connection identifier field has the predetermined length.
